(19) United States
(12) Patent Application Publication
(10) Pub. No.: US 2015/0243185 A1
(43) Pub. Date: Aug. 27, 2015

(54) Exercise Alignment Device

(71) Applicant: Bennette Purdy, Olympia, WA (US)

(72) Inventor: Bennette Purdy, Olympia, WA (US)

(21) Appl. No.: 14/594,243

(22) Filed: Jan. 12, 2015

Related U.S. Application Data
(60) Provisional application No. 61/945,540, filed on Feb. 27, 2014.

(51) Int. Cl. G09B 19/00

(52) U.S. Cl. CPC G09B 19/003; A63B 2225/12

(57) ABSTRACT

An exercise alignment device is provided that comprises a reflective surface supporting a plurality of markings thereon that promote symmetry, proper form, and range of motion during an exercise or athletic movement. Disposed centrally along the reflective surface is a vertical marking and a body reticle. Horizontal markings extend symmetrically outward from the sides of the vertical marking. Finally, a plurality of angular markings and complimentary angular marking indicia are provided that extend radially from the body reticle. The vertical marking promotes symmetry, while the horizontal markings ensure even and symmetrical body movements. Finally, the angular markings quantify range of motion and flexibility. A pair of light sources are provided that are used as moving markers on the reflective surface, whereby movement of the user and a bar member can be tracked. Finally, magnetic markers are provided for marking proper body placement and full extension reference markers.

### CROSS REFERENCE TO RELATED APPLICATION

This application claims the benefit of U.S. Provisional Application No. 61/945,540 filed on Feb. 27, 2014. The above identified patent application is herein incorporated by reference in its entirety to provide continuity of disclosure.

### BACKGROUND OF THE INVENTION

1. Field of the Invention

The present invention relates to exercise alignment devices and training visualization devices that allow monitoring of athletic movements. More specifically, the present invention relates to a mirror having athletic movement markings thereon, which are used as reference markings during weight lifting and other athletic activities to ensure proper posture and body position throughout the movement.

Proper body position is crucial for certain athletic activities and stretching exercises. This is particularly true in the area of weight lifting, where proper posture and body positioning throughout an athletic movement are important aspect for preventing injury while engaging in the movement. Many individuals train with free weights but are poorly trained or poorly educated on the proper movements. Moreover, it is difficult to monitor one's own movements without assistance from others. Improper movements with heavy weights can cause back strain, improper balance, and significant risk of injury. Along with health concerns, those lifting for strength and performance will want to maximize their efficiency throughout the lifting movements to achieve maximum effect.

Inconsistent training or repetitive athletic movements using an incorrect form and technique increases the likelihood of suffering injuries. These include back muscle and spine injuries, knee injuries, shoulder injuries, and others. While some may consider hiring trainers, this option is not widely available to many and is not always a possibility. Therefore, a need exists for assisting users conducting weight lifting movements and other body movements, whereby the user can view his or her body position throughout an exercise and modify the movement to correct for incorrect form.

There is dispute in the fitness community whether the use of a mirrors to visualize lifting and stretching exercises improves the exercise. Often mirrors in a gym are used entirely for aesthetic assessments instead of their intended purpose: monitoring one's body position throughout a movement. The present invention contemplates an improved mirror visualization device that allows the user to monitor his or her movements by reflection, but moreover to use a specifically arranged set of markings that form a “reticle” to monitor one's movement. Similar to a reticle on a firearm sight, the markings of the present invention are used as a guideline for an exercising user in order to ensure proper technique, range of motion, and overall form. The use of markings provides a universal and transferable guideline to measure dynamic movement and exercise for all individuals.

Specifically, the present invention provides a visual feedback system for weight lifters and athletes. The device comprises a reflective surface that is mounted to a wall or similarly supported such that a user can view himself or herself while engaging in a physical movement. Disposed along the reflective surface is an arrangement of alignment markings that are used to measure range of motion, ensure proper alignment throughout an exercise, and provide a guide for the user to view his or her motion during the movement. Centrally located on the surface is a reticle, which is used to align with the midpoint of the user. The various markings extending therefrom promote symmetry and body alignment as the user views his or her movements.

2. Description of the Prior Art

Devices have been disclosed in the prior art that relate to body position and alignment devices for athletic movements. These include devices that have been patented and published in patent application publications. The following is a list of devices deemed most relevant to the present disclosure, which are herein described for the purposes of highlighting and differentiating the unique aspects of the present invention, and further highlighting the drawbacks existing in the prior art.

Devices in the art relate largely to floor mat devices, whereby a floor mat is partitioned or otherwise marked with indicia such that a user engaged in floor mat exercises can position his or her body appropriately thereon while stretching or forming a specific body position. The present invention, by contrast, provides a reflective surface with guide markings, whereby the user can visualize his or her body movement throughout the exercise.

One such device in the prior art is U.S. Pat. No. 5,116,058 to Theriault, which discloses a golf training device that is designed to provide visual feedback to a swinging user using a mirror and a support assembly therefor. The mirror is tilted at an upward angle and placed at the side of a user engaging in a golf swing. By visualizing his or her swing in the mirror, flaws can be identified to correct the golf swing. The Theriault device provides an assembly that supports a tilting mirror with a centering spot located centrally along the mirror, whereby the assembly is supported along the ground and the mirror is aimed upward at the user. The present invention provides a mirror for visualizing an athletic movement; however the device herein includes several alignment and range of motion markings thereon. These indicia serve as reference lines, which allow a user to visualize his or her movement throughout an activity.

Another device in the art is U.S. Pat. No. 6,387,013 to Marquez, which discloses an assembly for verifying proper alignment during an exercise, whereby an alignment mat system is provided. The Marquez device comprises a cushioned mat material having orthogonal lines thereon that intersect and separate the mat into different quadrants. The markings allow for proper movements during yoga activities, where proper hand, foot, and body placement are important. While related to athletic movements and body position, the Marquez device fails to anticipate a reflective mirror having markings thereon for athletic movements. Rather, Marquez fulfills a need in the art of yoga and body part placement along the floor while stretching, extending, and positioning one's body during exercises.

Similar to Marquez is U.S. Pat. No. 7,819,777 to Service, which discloses an exercise alignment mat system having a plurality of grooves formed into the top surface thereof in the form of a grid pattern. Within each of the grids is a set of concentric square indicia, forming an indicator of where a user is to place his or her fingers and palm on the grid, respectively. As with Marquez, the Service device fails to contemplate the reflective surface of the present invention and the arrangement of markings thereon. The Service device is directed to a mat hand placement system rather than a visual body motion feedback surface.

U.S. Patent Publication No. 2004/0214692 to Koenig discloses yet another exercise grid system, whereby a mat is provided with a set of orthogonal grid lines thereon forming rectangles. Along the major sides of the mat are numerical markings, while the ends of the mat include alphabetic markings. The mat is placed on the floor and used in conjunction with floor exercises, similar to Marquez and Service. As with these similar devices, the Koenig device provides no visual feedback of the user's posture, body positioning or range of motion to the user beyond hand and foot placement on the mat. The present invention provides a reflective surface with markings, whereby the user's body positioning throughout an athletic movement can be monitored by the user, while the markings are used to ensure alignment, proper range of motion, and other factors related to performance of the movement.

The present invention provides a reflective surface having alignment and range of motion markings thereon to provide an exercising user with references such that the user can maintain proper posture, alignment, and proper form. Further provided is a system that combines the markings with a light source, whereby the light source is projected onto the reflective surface and is attached to the user or the exercise equipment being deployed for alignment purposes. The function and purpose of the present invention significantly diverges from the prior art. Consequently it is clear there is a need in the art for an improvement to existing exercise alignment devices. In this regard the instant invention substantially fulfills these needs.

### SUMMARY OF THE INVENTION

In view of the foregoing disadvantages inherent in the known types of exercise alignment devices now present in the prior art, the present invention provides a new exercise visualization system that can be utilized for ensuring alignment, proper technique, and proper range of motion during an athletic movement.

It is therefore an object of the present invention to provide a new and improved exercise alignment device that has all of the advantages of the prior art and none of the disadvantages.

It is another object of the present invention to provide an exercise alignment device that comprises a reflective surface having a plurality of alignment markings thereon for reference by the user as he or she views their body position throughout an athletic movement.

Another object of the present invention is to provide an exercise alignment device that is used to build and maintain midline stability and symmetry throughout all lifts and dynamic movements, using visual feedback as a guide.

Another object of the present invention is to provide an exercise alignment device that can be used to measure and quantify individual movement techniques to ensure each repetition is completed with proper form.

Yet another object of the present invention is to provide an exercise alignment device that can be used to ensure proper posture and form to prevent injury while lifting.

Another object of the present invention is to provide an exercise alignment device that be used to ensure full range movements, identify poorly integrated movement patterns, and expose areas reduced strength, speed, and mobility.

Another object of the present invention is to provide an exercise alignment device that can be used as an visual feedback tool during rehabilitation work, whereby a user can measure improvements in flexibility, range of motion, and furthermore receive positive feedback during the exercise through body movement visualization.

Yet another object of the present invention is to provide an exercise alignment device that can be utilized in conjunction with a light source, whereby the light is directed onto the reflective surface and used in conjunction with the markings as a guide during an exercise.

A final object of the present invention is to provide an exercise alignment device that provides horizontal markings, vertical markings, and angular markings for symmetrical movement, balance, and for measuring range of motion.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a first embodiment of the exercise alignment device of the present invention.

FIG. 2 shows a second embodiment of the exercise alignment device of the present invention.

FIG. 3 shows a third embodiment of the exercise alignment device of the present invention.

FIG. 4 shows a view of the device being used with the light source marker system of the present invention.

### DETAILED DESCRIPTION OF THE INVENTION

Reference is made herein to the attached drawings. Like reference numerals are used throughout the drawings to depict like or similar elements of the exercise alignment device of the present invention. For the purposes of presenting a brief and clear description of the present invention, the preferred embodiment will be discussed as used for providing visual feedback to a user engaged in athletic movements. The figures are intended for representative purposes only and should not be considered to be limiting in any respect.

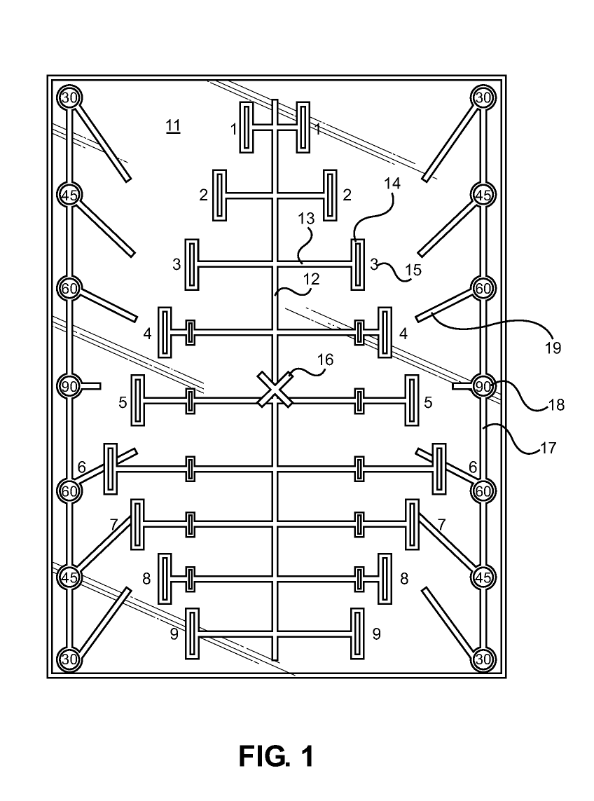

Referring now to FIG. 1, there is shown a frontal view of the exercise alignment device of the present invention. The device comprises a reflective surface 11 that is adapted to be supported in a vertical orientation and provide visual feedback to a user standing in front of the device during an exercise. Disposed on the reflective surface 11 is a plurality of markings that are designed to, inter alia, improve symmetry during the exercise movement, ensure proper form, and measure range of motion during an exercise.

Several markings are provided on the device for various purposes. A central vertical marking 12 is disposed centrally along the surface 11 such that the user can align his or her body along the centerline of the surface 11. Along the central vertical marking 12 is a reticle 16, which is designed to be pinpointed on the user's chest. The mounting location of the reflective surface on a support wall is determined based on the location of the reticle 16 relative to the user's chest while standing (or sitting, if exercises are to be conducted while seated). The central vertical marking 12 is employed so the user can center his or her body along the centerline of the reflective surface 11, whereby all other markings extend relative to the central vertical marking 12 and the reticle 16.

Extending outward along both sides of the central vertical marking 12 are a plurality of horizontal markings 13. The horizontal markings 13 are stacked vertically along the length of the central vertical marking 12 and extend horizontally outward therefrom. The horizontal markings extend symmetrically in distance from the vertical marking, and are employed for various purposes. The first purpose is to ensure symmetry during an exercise. As a user lifts his or her arms or legs, the horizontal markings 13 can be used to measure the height of each side of the user's body. Misalignments during a movement, either caused by asymmetrical strength or improper form, can be measured against the horizontal markings 13. When mounting the reflective surface, therefore, it is critical that the reflective surface 11 is level and the horizontal markings 13 are indeed horizontal.

A second function of the horizontal markings 13 is to align a weight bar with the horizontal portion and vertical ends of the horizontal marking 13 during a lift or movement. The ends of the horizontal markings 13 include vertical sections. When the reflective surface 11 is used in conjunction with a pair of light sources (e.g. a pair of laser pointers) disposed on a lifting bar, the reflected light can be used to trace the path of the bar over the ends 14 and the horizontal sections of specific horizontal markings 13. Tracing them over the ends 14 ensures the lift is being conducted symmetrically about the vertical marking 12, while tracing over the horizontal portions ensures the bar is even as the reflected light traverses the horizontal portions at the same time throughout the exercise.

Along the sides of the reflective surface 11 are a second set of vertical markings 17 that span the height of the surface 11 and align a plurality of angular measurement indicia 18. Along the outer vertical markings 17 are several spaced angular measurement indicia 18. The angular measurement indicia 18 correspond to the angle between the vertical marking 12 and an angular marking 19 that extends from the indicia 18 to the reticle 16. The angular marking 19 is used to measure the range of motion of a user's limbs during an exercise, whereby the angular degree with which a limb is moved during an exercise can be verified. This is helpful when ensuring full range of motion during a lift, and furthermore for tracking progress during rehabilitation, where improvements in range of motion can be measured.

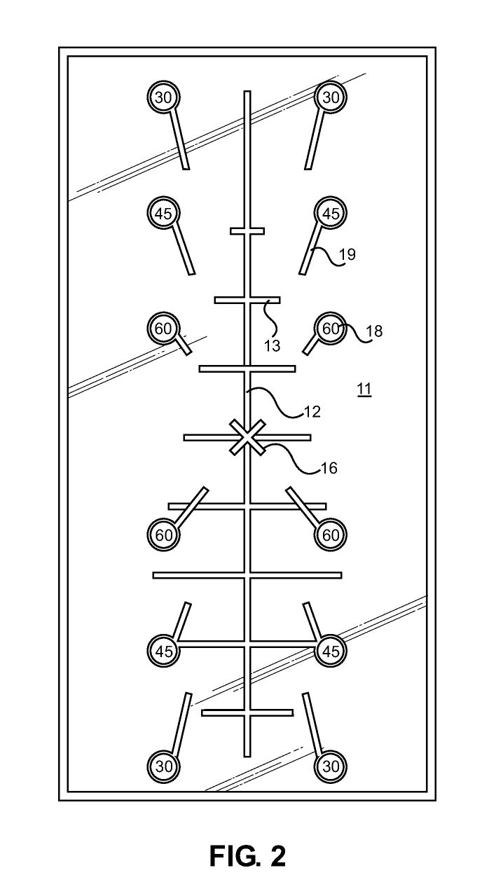

Referring now to FIG. 2, there is shown a view of an alternate embodiment of the present invention, whereby the reflective surface 11 supports angular, horizontal, and vertical markings in a different arrangement than shown in FIG. 1. The arraignment of FIG. 2 is useful for more narrow surfaces 11 and in situations in which a wider surface may not be appropriate. As shown, the surface 11 supports a central vertical marking 12 that extends vertically and is centered thereon for symmetry purposes. Extending horizontally from the vertical marking 12 are a plurality of horizontal markings 13, which extend outward and provide an alignment tool during a vertical lift. Finally, angular markings 19 are provided on the surface 11, whereby angular measurement indicia 18 are disposed along the sides of the vertical marking 12 and provide angular markings 19 extending therefrom and to a central reticle 16. In this embodiment, the angular measurement indicia 18 may or may not be connected by outer vertical markings 17, and the overall arrangement of the markings is more condensed and more centrally located on the narrower surface 11.

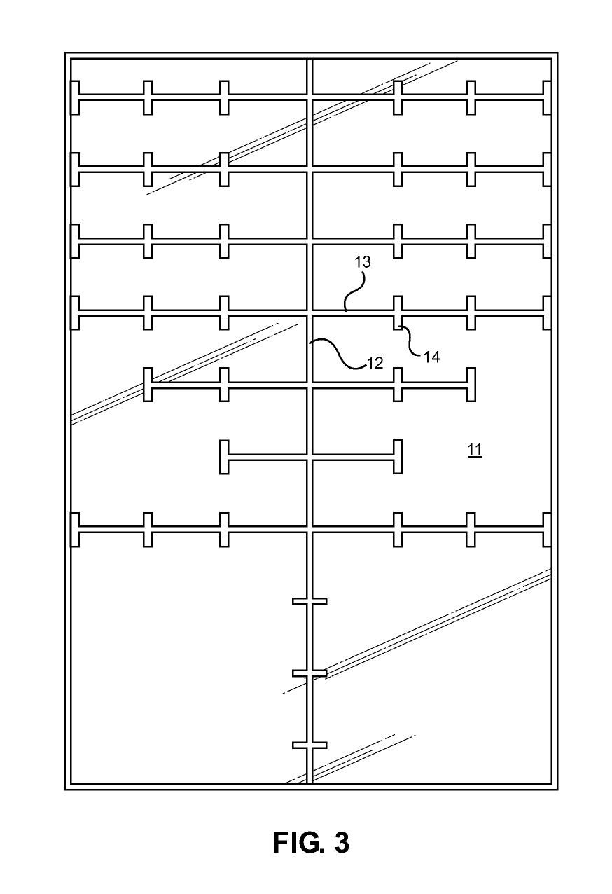

Referring finally to FIG. 3, there is shown a third embodiment of the present invention, whereby angular markings are not provided. This embodiment is more suitable for vertical lifting movements using bar weights (i.e. squats, deadlifts, etc.), as opposed to dumbbell lifts in which angular range of motion is necessary. Disposed on the reflective surface 11 in this third embodiment are several horizontal markings 13 that extend outward from a central vertical marking 12. The horizontal markings 13 vary in length and include vertical portions 14 thereon for visualizing a light source disposed on a weight bar. As with the aforementioned embodiments, the vertical marking 12 promotes symmetry by separating the sides of the user's body into separate halves of the surface 11. The horizontal markings ensure proper form and uniform lifting along opposite sides of the user's body.

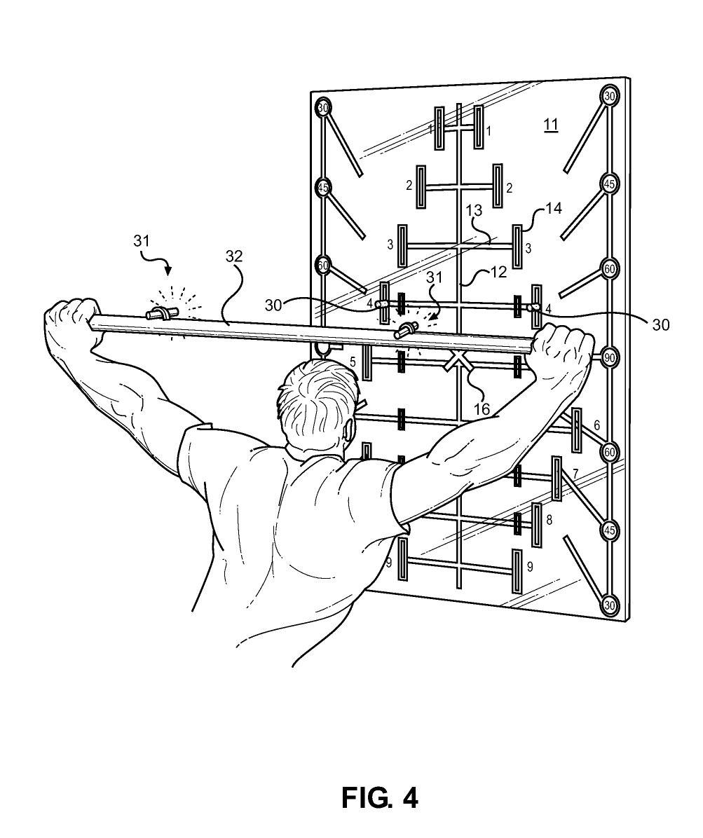

Referring now to FIG. 4, there is shown a view of the reflective surface of the present invention in a working state. During a lifting exercise, it is contemplated that a pair of light sources 31 be placed on the lifting bar 32. The light sources 31 are preferably laser pointers or LED lights, which centralize the outgoing light and allow the light to pinpoint one localized location on the reflective surface 11. Using a pair of light sources 31 allows the angle of the bar 32 to be monitored throughout the exercise, while also monitoring the height of the bar as the light source reflection traverses the surface 11.

During a lifting exercise with a bar supporting the light sources 31, the reflected dot of each light source on the surface 11 moves along a vertical path. The pair of dots traverses the horizontal markings 13 and is disposed on opposite sides of the vertical marking 12. The user can monitor the dots to ensure the dots cross each horizontal marking 13 at the same time (i.e. the bar is level), and the dots are equidistant from the vertical marking 12 (i.e. that the user is centered and symmetrical throughout the lift). Prior to the lift, the user ensures the central reticle 16 is centered on the user and the user is standing (or sitting) in alignment with the vertical marking 12.

To assist the user in aligning his or her body with the surface 11, magnetic markers 30 may be applied thereto. The reflective surface includes a ferromagnetic construction that allows magnets to be affixed to the outer surface thereof. The magnetic markers 30 are configured to affix to the reflective surface and extend outward therefrom by as much as several inches to several feet. These are used as guides or “spotters” for the user to measure his or her range of motion. The backing of the reflective surface is a metallic material in order to secure the magnetic markers thereon. The magnetic markers are removable from the mirror, and may be placed in different positions and angles along the mirror in order to assist an individual when performing a given exercise. For example, the markers can designate the proper placement of feet when performing squats or other exercises, and/or may provide a means for checking a range of movement during athletic movements (e.g. golf swings, weight lifting, kicks during dance moves, and the like).

The present invention provides a reflective surface and feedback system that integrates the principles of marksmanship into an effective and multi-dimensional body placement and movement training tool. The surface is designed to offer benefits to athletes, coaches, trainers or any active individuals looking to push themselves in order to achieve perfect form and consistency in their training. This is accomplished by promoting the building and maintenance of midline stability and symmetry throughout lifts and dynamic athletic movements. Use of the markings as reference throughout an exercise, and the ability to view one's movements, allows an individual to measure and quantify individual movement techniques and multiple form checkpoints on a single focal plane and provides a framework to help individuals identify poorly integrated movement patterns and imperfect technique. Further, the device of the present invention is adapted for assisting individuals with rehabilitation and physical therapy in order to help expedite recovery.

The present invention has several goals, include (1) building and maintaining midline stability and symmetry throughout all lifts and dynamic movements; (2) measuring and quantifying individual movement techniques to ensure every repetition is completed with proper form; (3) prevent injuries during athletic movements and training; (4) emphasize full range movements; (5) identify poorly integrated movement patterns and gaps in strength, speed and mobility restrictions; and finally, (5) provide a rehabilitation tool that can quantify flexibility and range of motion. The markings of the surface are adapted to teach form and proper technique, fix poor movement habits, improve rehabilitation efforts, and ensure athletic movements are completed correctly and repeated correctly.

The markings on the reflective surface provide a means that enables users to perfect their movements during an athletic activity. This is accomplished by providing a reflective surface with a reticle that enables an individual to incorporate the principles, precision and discipline of marksmanship into their physical fitness and athletic training. The precision of a marksman's shot depends on an intimate knowledge of their form and how that sequence impacts their technique and aim. The reflective surface (preferably a mirror surface) comprises a variety of marking lines thereon that enable an individual to carefully study their movements when performing a task. The markings are designed to resemble a reticle in a hunting scope in order to allow athletes to develop the same type of precision in the form of their movements and improve their technique by comparing movements against an array of quantifiable markings. The horizontal, vertical, and angular markings act as a standardized tool that provides people with several reference points throughout an exercise to compare their form and technique to ensure that their first repetition is done exactly the same as their last

Several uses are contemplated, including weight lifting, dance movements, rehabilitation, and golf swing practice. The angular markings enable a user to monitor his or her movements when used with a weighted device or during a golf swing, whereby the swing angle and range of motion is measurable. Another example of their use includes pull cables, whereby a user pulls pull cables and pulls them towards the reticle at an identical angle each time. Many different types of exercises can be monitored using the disclosed markings.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. An exercise alignment device, comprising:
a reflective surface having a centerline, outer side edges, an upper edge, and lower edge;
a vertical marking disposed along said centerline of said reflective surface and extending a length between said upper edge and said lower edge;
a plurality of horizontal markings cross said vertical marking and separated from one another long said length;
said horizontal markings being centered on said vertical marking and extending horizontally therefrom an equidistant distance;
one or more pairs of vertical portions extending vertically from said horizontal markings, said pairs comprising a first and second vertical portion disposed symmetrically about said vertical marking;
a central reticle disposed along said vertical marking;
a plurality of angular markings, each extending from an angular measurement indicia and towards said central reticle;
said angular measurement indicia disposed along symmetrically about said vertical marking;
the angular measurement indicia of each angular marking displaying an angular measurement between said angular marking and said vertical marking.

2. The exercise alignment device of claim 1, wherein:
said reflective surface comprises a ferromagnetic construction that supports magnets thereon;
one or more pairs of magnetic markers affixable to said reflective surface;
said magnetic markers having a magnetic base and a length extending therefrom.

3. The exercise alignment device of claim 1, further comprising:
a pair of light sources affixable to a bar member, said light sources projecting localized light therefrom such that each light source can be identified on said bar member and tracked along said reflective surface throughout an exercise movement.

4. An exercise alignment device, comprising:
a reflective surface having a centerline, outer side edges, an upper edge, and lower edge;
a vertical marking disposed along said centerline of said reflective surface and extending a length between said upper edge and said lower edge;
a plurality of horizontal markings cross said vertical marking and separated from one another long said length;
said horizontal markings being centered on said vertical marking and extending horizontally therefrom an equidistant distance;
one or more pairs of vertical portions extending vertically from said horizontal markings, said pairs comprising a first and second vertical portion disposed symmetrically about said vertical marking.

5. The exercise alignment device of claim 4, further comprising:
a central reticle disposed along said vertical marking;
a plurality of angular markings, each extending from an angular measurement indicia and towards said central reticle;
said angular measurement indicia disposed along symmetrically about said vertical marking;
the angular measurement indicia of each angular marking displaying an angular measurement between said angular marking and said vertical marking.

6. The exercise alignment device of claim 4, wherein:
said reflective surface comprises a ferromagnetic construction that supports magnets thereon;
one or more pairs of magnetic markers affixable to said reflective surface;
said magnetic markers having a magnetic base and a length extending therefrom.

7. The exercise alignment device of claim 4, further comprising:
a pair of light sources affixable to a bar member, said light sources projecting localized light therefrom such that each light source can be identified on said bar member and tracked along said reflective surface throughout an exercise movement.
